(19) United States
(12) Patent Application Publication
(10) Pub. No.: US 2024/0417555 A1
(43) Pub. Date: Dec. 19, 2024

(54) COMPOSITIONS OBTAINED FROM RECYCLED POLYOLEFINS

(71) Applicant: Basell Poliolefine Italia S.r.l., Milano (IT)

(72) Inventors: Claudio Cavalieri, Ferrara (IT); Monica Galvan, Ferrara (IT)

(73) Assignee: Basell Poliolefine Italia S.r.l., Milano (IT)

(21) Appl. No.: 18/720,913

(22) PCT Filed: Dec. 7, 2022
(86) PCT No.: PCT/EP2022/084747

§ 371 Date: Jun. 17, 2024

(30) Foreign Application Priority Data
Dec. 22, 2021 (EP) 21216708.4

(51) Int. Cl. C08L 23/14

(52) U.S. Cl. CPC C08L 23/14; C08L 2203/16; C08L 2205/035; C08L 2205/08; C08L 2207/02; C08L 2207/20

(57) ABSTRACT

A polyolefin composition made from or containing:
(A) 60-95 wt % of a polyolefin component being a mixture of a polypropylene based component and a polyethylene based component and
(B) 5-40% a polypropylene composition made from or containing (b1) from 35 to 65% by weight of a polymer fraction made from or containing a propylene homopolymer, or a copolymer containing at least 85% of propylene-derived units, and (b2) from 35 to 65% by weight of a polymer fraction made from or containing a copolymer of ethylene with propylene or CH₂═CHR alpha-olefins, wherein the copolymer containing ethylene in an amount from 25 to 40% by weight.

### FIELD OF THE INVENTION

In general, the present disclosure relates to the field of chemistry. More specifically, the present disclosure relates to polymer chemistry. In particular, the present disclosure relates to compositions made from or containing recycled polyolefins and a polypropylene based composition.

### BACKGROUND OF THE INVENTION

Polyolefins are consumed for applications, including packaging for food and other goods, fibers, automotive components, and manufactured articles. The quantity of polyolefins raises concerns for the environmental impact of the waste materials generated after the first use of the polyolefins.

Waste plastic materials are coming from differential recovery of municipal plastic wastes. In some instances, municipal plastic waste includes flexible packaging (cast film, blown film, and BOPP film), rigid packaging, blow-molded bottles, and injection-molded containers. Through a step of separation from other polymers, polyolefin fractions are obtained. The polyolefin fractions include polyethylene and polypropylene polymers. In some instances, the polyethylene polymers are HDPE, LDPE, or LLDPE. In some instances, the polypropylene polymers are homopolymers, random copolymers, or heterophasic copolymers.

A challenge in polyolefin recycling is separating quantitatively polypropylene (PP) and polyethylene (PE). In some instances, commercial recyclates from post-consumer waste (PCW) sources contain mixtures of PP and PE, wherein the minor component is up to <50 wt %.

In some instances, the recycled PP/PE-blends suffer from deteriorated mechanical and optical properties, poor performance in odor and taste, and poor compatibility between the polymer phases, thereby adversely affecting impact strength and heat deflection resistance. It is believed that the performance is partly caused by PE, having lower stiffness and melting point, forming the continuous phase, even when PP concentrations are up to 65%. It is further believed that PE forms the continuous phase because the PE components in PCW have higher viscosity than the PP components.

In some instances, the recycled PP/PE-blends are excluded from use in high quality parts. Alternatively, the recycled PP/PE-blends are used in low-cost and non-demanding applications.

### SUMMARY OF THE INVENTION

In a general embodiment, the present disclosure provides a polyolefin composition made from or containing:
(A) 60-95 wt % of a polyolefin component made from or containing
   (a1) from 20 wt % to 80 wt % of a propylene based polymer, having a propylene content higher than 60 wt %; and
   (a2) from 20 wt % to 80 wt % of an ethylene based polymer, having an ethylene content higher than 70 wt %; and
(B) 5-40 wt % of a polypropylene composition made from or containing
   (b1) from 35 to 65% by weight of a polymer fraction made from or containing a propylene homopolymer, or a copolymer of propylene with one or more comonomers selected from the group consisting of ethylene and CH₂═CHR alpha-olefins, where R is a C₂-C₈ alkyl radical, or mixtures thereof,
   wherein the copolymers containing at least 85% by weight of units derived from propylene, and
   (b2) from 35 to 65% by weight of a polymer fraction made from or containing a copolymer of ethylene with comonomers selected from the group consisting of propylene and CH₂═CHR alpha-olefins, where R is a C₂-C₈ alkyl radical,
   wherein the copolymer containing units derived from ethylene in an amount ranging from 25 to 40% by weight,
   wherein the polypropylene composition (B) having
      a Melt Flow Rate (ISO 1133 230° C./2.16 kg) ranging from 0.1 to 5 g/10 min;
      an amount of fraction soluble in xylene at room temperature (25° C.) ranging from 35 to 60% by weight,
   wherein the soluble fraction having an intrinsic viscosity, measured in tetrahydronaphthalene at 135° C., ranging from 3.0 to 7.5 dl/g; and
      a total content of ethylene, determined by ¹³C-NMR, ranging from 10 to 25% by weight;
         wherein the sum of a1) and a2), being referred to the total weight of a1) and a2), is 100, the sum of b1) and b2), being referred to the total weight of b1) and b2), is 100, and the sum of the amounts of (A) and (B), being referred to the total weight of (A) and (B), is 100.

### DETAILED DESCRIPTION OF THE INVENTION

In some embodiments, the polyolefin composition is made from or containing:
(A) 60-95 wt % of a polyolefin component made from or containing
   (a1) from 20 wt % to 80 wt % of a propylene based polymer, having a propylene content higher than 60 wt %; and
   (a2) from 20 wt % to 80 wt % of an ethylene based polymer, having an ethylene content higher than 70 wt %, and
(B) 5-40 wt % of a polypropylene composition made from or containing
   (b1) from 35 to 65% by weight, alternatively from 40 to 60% by weight, of a polymer fraction made from or containing a propylene homopolymer, or a copolymer of propylene with one or more comonomers selected from the group consisting of ethylene and CH₂═CHR alpha-olefins, where R is a C₂-C₈ alkyl radical, or mixtures thereof,
   wherein the copolymers containing at least 85% by weight of units derived from propylene, and
   (b2) from 35 to 65% by weight, alternatively from 40 to 60% by weight, of a polymer fraction made from or containing a copolymer of ethylene with comonomers selected from the group consisting of propylene and CH₂═CHR alpha-olefins, where R is a C₂-C₈ alkyl radical,
   wherein the copolymer containing units derived from ethylene in an amount ranging from 25 to 40% by weight, alternatively from 28 to 35% by weight,
   wherein the polypropylene composition (B) having
      a Melt Flow Rate (ISO 1133 230° C./2.16 kg) ranging from 0.1 to 5 g/10 min, alternatively from 0.2 to 2.5 g/10 min;
      an amount of fraction soluble in xylene at room temperature (25° C.) ranging from 35 to 60% by weight, alternatively from 40 to 55% by weight,
   wherein the soluble fraction, having an intrinsic viscosity, measured in tetrahydronaphthalene at 135° C., ranging from 3.0 to 7.5 dl/g, alternatively from 4.0 to 6.5 dl/g; and
      a total content of ethylene, determined by ¹³C-NMR, ranging from 10 to 25% by weight, alternatively from 13 to 23% by weight;
         wherein the sum of a1) and a2), being referred to the total weight of a1) and a2), is 100, the sum of b1) and b2), being referred to the total weight of b1) and b2), is 100, and the sum of the amounts of (A) and (B), being referred to the total weight of (A) and (B), is 100.

As used herein, the term “copolymer” refers to both polymers with two different recurring units and polymers with more than two different recurring units, such as terpolymers, in the chain. As used herein, the term “ambient or room temperature” refers to a temperature of about 25° C.

As used herein, the term “consisting essentially of” refers to, in connection with a polymer or polymer composition made from or containing mandatory components, the polymer or polymer composition optionally further having other components present, provided that the essential characteristics of the polymer or polymer composition are not materially affected by the presence of the other components. In some embodiments, components that do not materially affect characteristics of the polymer or polymer composition are selected from the group consisting of catalyst residues, antistatic agents, melt stabilizers, light stabilizers, antioxidants, and antacids.

The features of the components forming the polypropylene composition are not inextricably linked to each other. In some embodiments, a level of a feature does not involve the same level of the remaining features of the same or different components. In some embodiments, any component or sub-components (A) to (B) and any range of features of components (A) to (B) is combined with any range of one or more of the features of components (A) to (B) and with any possible additional component, and the component's features.

In some embodiments, component (A) is in an amount ranging from 60 to 95 wt %, alternatively from 65 to 95 wt %, alternatively 75 to 95 wt %; alternatively from 80 to 95 wt %, based on the sum of (A) and (B).

In some embodiments, component (B) is in an amount ranging from 5 to 40 wt %, alternatively from 5 to 35 wt %, alternatively from 5 to 25 wt %; alternatively from 5 to 20 wt %, based on the sum of (A) and (B).

In some embodiments, the amount of component a1) ranges from 20 wt % to 80 wt %, alternatively from 30 wt % to 70 wt %, alternatively from 40 wt % to 60 wt %, alternatively from 45 wt % to 55 wt %, based on the sum of a1)+a2). In some embodiments, component a1) is a propylene based polymer, having a propylene content higher than 60 wt %, alternatively higher than 70 wt %; alternatively higher than 80 wt %, alternatively in the range of from 90 wt % to 100 wt %;

In some embodiments, the amount of component (a2) ranges from 20 wt % to 80 wt %, alternatively from 30 wt % to 70 wt %, alternatively from 40 wt % to 60 wt %, alternatively from 45 wt % to 55 wt %, based on the sum of a1)+a2). In some embodiments, component (a2) is selected from ethylene based polymers, having an ethylene content higher than 70 wt %, alternatively higher than 75 wt %; alternatively higher than 80 wt %, alternatively in the range of from 90 wt % to 100 wt %.

In some embodiments, component (A) originates from a waste material containing not less than 80% by weight, alternatively not less than 90% by weight, alternatively from 80% or 90% up to 99% by weight, with respect to the total weight of the component, of polyethylene, polypropylene, or mixtures thereof. As used herein, the term “waste” refers to polymer materials deriving from at least one cycle of processing into manufactured articles, as opposed to virgin polymers.

In some embodiments, multiple kinds of polyethylene or polypropylene are present. In some embodiments, the polyethylene fraction is made from or containing one or more materials selected from the group consisting of high density polyethylene (HDPE), low density polyethylene (LDPE), and linear low density polyethylene (LLDPE).

In some embodiments, the polypropylene fraction is made from or containing one or more polymer materials selected from the group consisting of
I) isotactic or mainly isotactic propylene homopolymers;
II) random copolymers of propylene with ethylene or C4-C8 α-olefins, wherein the total comonomer content ranges from 0.05% to 20% by weight; and
III) heterophasic copolymers made from or containing (a) a propylene homopolymer or one of the copolymers of item II), and (b) an elastomeric fraction made from or containing copolymers of ethylene with propylene or a C4-C8 α-olefin, optionally containing minor amounts of a diene, such as butadiene, 1,4-hexadiene, 1,5-hexadiene, ethylidene-1-norbornene. In some embodiments, the C4-C8 α-olefins are selected from the group consisting of 1-butene, 1-hexene, 1-octene, and 4-methyl-1-pentene. In some embodiments, the diene is selected from the group consisting of butadiene, 1,4-hexadiene, 1,5-hexadiene, ethylidene-1-norbornene.

In some embodiments, other polymeric materials are present as impurities in component (A) and are selected from group consisting of polystyrene, ethylene vinyl acetate copolymers, and polyethylene terephthalate.

In some embodiments, other impurities are present in component (A) and are selected from the group consisting of are metals and additives. In some embodiments, the metals are aluminum. In some embodiments, the additives are fillers or pigments.

In some embodiments, component (B) is present in an amount ranging from 5 to 40 wt %, alternatively from 5 to 35 wt %, alternatively from 5 to 25 wt %; alternatively from 5 wt % to 20 wt %, based on the sum of (A+B).

In some embodiments, component (b1) is selected from a propylene homopolymer or a propylene ethylene copolymer containing from 0.1 to 6.0% by weight, alternatively from 0.5 to 5.0% by weight of ethylene.

In some embodiments, component (b2) is selected from a copolymer of ethylene and propylene containing units derived from ethylene in an amount ranging from 25 to 40% by weight, alternatively from 28 to 35% by weight.

In some embodiments, polypropylene composition (B) has
a Melt Flow Rate (ISO 1133 230° C./2.16 kg) ranging from 0.1 to 5 g/10 min, alternatively from 0.2 to 2.5 g/10 min, alternatively from 0.3 to 2.0 g/10 min;
an amount of fraction soluble in xylene at room temperature (25° C.) ranging from 35 to 60% by weight, alternatively from 40 to 55% by weight, alternatively from 45 to 55% by weight, wherein the soluble fraction, having an intrinsic viscosity, measured in tetrahydronaphthalene at 135° C., ranging from 3.0 to 7.5 dl/g, alternatively from 4.0 to 6.5 dl/g, alternatively from 4.5 to 6.5 dl/g; and,
a total content of ethylene, determined by ¹³C-NMR, ranging from 10 to 25% by weight, alternatively from 13 to 23% by weight, alternatively from 15 to 23% by weight.

In some embodiments, the Melt Flow Rate (ISO 1133 230° C./2.16 kg) of the whole polyolefin composition ranges from 0.5 to 30 g/10 min, alternatively from 0.5 to 20 g/10 min, alternatively from 0.5 to 15 g/10 min.

In some embodiments, the polyolefin composition is use for preparing films, including cast, blown, and bioriented films mono or multilayer. In some embodiments, the present disclosure provides an article of manufacture made from the polyolefin composition. In some embodiments, the article of manufacture is extruded or molded. In some embodiments, the article of manufacture is a films, alternatively a cast, blown, and bioriented films mono or multilayer.

In some embodiments, the fraction (a2) is greater than (a1), the elastic modulus is equal to, or higher than 850 N/mm², and the ratio between the value of elastic modulus and the Charpy resistance at 23° C. is lower than 12. In some embodiments, the polyolefin composition is further made from or containing an inorganic additive, the elastic modulus is equal to, or higher than 950 N/mm², and the ratio between the value of elastic modulus and the Charpy resistance at 23° C. is lower than 15. In some embodiments, the inorganic additive is talc.

In some embodiments, the fraction (a1) is greater than (a2), the elastic modulus is equal to, or higher than 950 N/mm², and the ratio between the value of elastic modulus and the Charpy resistance at 23° C. is lower than 65.

In some embodiments, the polypropylene composition (B) is prepared by polymerization in sequential polymerization stages, with each subsequent polymerization being conducted in the presence of the polymeric material formed in the immediately preceding polymerization reaction. In some embodiments, the polymerization stages are carried out in the presence of a Ziegler-Natta catalyst. In some embodiments, the polymerization stages are carried out in the presence of a catalyst made from or containing the product of the reaction between:
i) a solid catalyst component made from or containing Ti, Mg, Cl, and an internal electron donor compound;
ii) an alkylaluminum compound and,
iii) an external electron-donor compound having the formula:
(R⁷)a(R⁸)bSi(OR⁹)c, where a and b are integers from 0 to 2, c is an integer from 1 to 4, and the sum (a+b+c) is 4; R⁷, R⁸, and R⁹ are alkyl, cycloalkyl, or aryl radicals with 1-18 carbon atoms optionally containing heteroatoms.

In some embodiments, the internal donor is selected from the esters of mono or dicarboxylic organic acids such as benzoates, malonates, phthalates, and succinates. In some embodiments, the internal donors are as described in U.S. Pat. No. 4,522,930A, European Patent No. 045977A2, and Patent Cooperation Treaty Publication Nos. WO 00/63261 and WO 01/57099. In some embodiments, the internal donor is selected from the group consisting of phthalic acid esters. In some embodiments, the phthalic acid ester is selected from the group consisting of diisobutyl phthalate, dioctyl phthalate, diphenyl phthalate, and benzyl-butyl phthalate.

In some embodiments, the particles of solid component (i) have substantially spherical morphology and an average diameter ranging between 5 and 150 m, alternatively from 20 to 100 m, alternatively from 30 to 90 m. As used herein, the term “substantially spherical morphology” refers to particles having the ratio between the greater axis and the smaller axis equal to or lower than 1.5, alternatively lower than 1.3.

In some embodiments, the solid catalyst component (i) is prepared by reacting a titanium compound of formula Ti(OR)q-yXy, where q is the valence of titanium and y is a number between 1 and q, with a magnesium chloride deriving from an adduct of formula MgCl2·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100-130° C.). Then, the adduct is mixed with an inert hydrocarbon immiscible with the adduct, thereby creating an emulsion which is quickly quenched causing the solidification of the adduct in form of spherical particles. In some embodiments, the procedure for the preparation of the spherical adducts is as disclosed in U.S. Pat. Nos. 4,399,054 and 4,469,648. In some embodiments, the resulting adduct is directly reacted with Ti compound or subjected to thermal controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80-130° C. and maintained at this temperature for 0.5-2 hours. In some embodiments, the treatment with TiCl₄ is carried out one or more times. In some embodiments, the electron donor compound is added during the treatment with TiCl₄.

In some embodiments, the alkyl-Al compound (ii) is selected from the group consisting of trialkyl aluminum compounds, alkylaluminum halides, alkylaluminum hydrides, and alkylaluminum sesquichlorides. In some embodiments, the alkyl-Al compound (ii) is a trialkyl aluminum compound selected from the group consisting of triethylaluminum, triisobutylaluminum, tri-n-butylaluminum, tri-n-hexylaluminum, and tri-n-octylaluminum. In some embodiments, the alkyl-Al compound (ii) is an alkylaluminum sesquichloride selected from the group consisting of AlEt₂Cl and Al₂Et₃Cl₃. In some embodiments, the alkyl-Al compound (ii) is a mixture including trialkylaluminums. In some embodiments, the Al/Ti ratio is higher than 1, alternatively between 50 and 2000.

In some embodiments, the silicon compounds (iii) are wherein a is 1, b is 1, c is 2, at least one of R⁷ and R⁸ is selected from branched alkyl, cycloalkyl, or aryl groups with 3-10 carbon atoms optionally containing heteroatoms, and R⁹ is a C₁-C₁₀ alkyl group. In some embodiments, R⁹ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)(2-ethylpiperidinyl)dimethoxysilane, and methyl(3,3,3-trifluoro-n-propyl)dimethoxysilane. In some embodiments, the silicon compounds are wherein a is 0, c is 3, R⁸ is a branched alkyl or cycloalkyl group, optionally containing heteroatoms, and R⁹ is methyl. In some embodiments, the silicon compounds are selected from the group consisting of cyclohexyltrimethoxysilane, t-butyltrimethoxysilane, and thexyltrimethoxysilane.

In some embodiments, the amount of external electron donor compound (iii) provides a molar ratio between the alkylaluminum compound and the external electron donor compound (iii) of from 0.1 to 200, alternatively from 1 to 100, alternatively from 3 to 50.

In some embodiments, the polymerization process for preparing the polypropylene compositions B) is as described in European Patent Application No. EP-A-472946, the relevant part of which is incorporated herein by reference.

In some embodiments, the polymerization stages occur in gas phase. In some embodiments, the reaction temperature in the polymerization stage for the preparation of the polymer fraction (b1) and in the preparation of the copolymer fraction (b2) are the same or different. In some embodiments, the reaction temperature in the polymerization stage is from 40° C. to 90° C. In some embodiments, the reaction temperature ranges from 50 to 80° C. in the preparation of the fraction (b1). In some embodiments, the reaction temperature ranges from 40 to 80° C. for the preparation of components (b2). In some embodiments, the pressure of the polymerization stages to prepare the fractions (b1) and (b2) is from 5 to 30 bar in gas phase. In some embodiments, the residence times relative to the two stages determines the ratio between the fractions (b1) and (b2). In some embodiments, the residence times range from 15 minutes to 8 hours. In some embodiments, molecular weight regulators are used. In some embodiments, the molecular weight regulators are chain transfer agents. In some embodiments, the molecular weight regulator is hydrogen or ZnEt₂.

In some embodiments, the polypropylene composition made from or containing polymer fraction (b1) and polymer fraction (b2) is subjected to a chemical treatment with organic peroxides, thereby lowering the average molecular weight and increasing the melt flow index.

In some embodiments, the polypropylene composition (B) is subjected to a grafting process in the presence of polar monomers such as maleic anhydride, thereby rendering the polypropylene composition (B) more compatible with polymers containing polar monomers present as minor components in the composition (A).

In some embodiments, the polyolefin composition is obtained by mechanical blending components (A) and (B).

In some embodiments, component (B) is mechanically blended with a preformed polyolefin composition (A) made from or containing components (a1) and (a2). In some embodiments, polyolefin component (A) is prepared from a sequential copolymerization process.

In some embodiments, the polyolefin composition is further made from or containing additives, fillers, and pigments. In some embodiments, the additives are nucleating agents. In some embodiments, the fillers are extension oils or mineral fillers. In some embodiments, the pigments are selected from the group consisting of organic and inorganic pigments. In some embodiments, the fillers are inorganic fillers selected from the group consisting of talc, calcium carbonate, and mineral fillers. In some embodiments, the fillers improve mechanical properties, such as flexural modulus and HDT. In some embodiments, talc has a nucleating effect.

In some embodiments, nucleating agents are added in quantities ranging from 0.05 to 2% by weight, alternatively from 0.1 to 1% by weight, with respect to the total weight.

The following examples are given to illustrate, but not limit the present disclosure.

### EXAMPLES

### Characterizations

### Xylene-Soluble (XS) Fraction at 25° C.

### Solubility in Xylene: Determined as Follows:

2.5 g of polymer and 250 ml of xylene were introduced into a glass flask equipped with a refrigerator and a magnetic stirrer. The temperature was raised in 30 minutes up to the boiling point of the solvent. The resulting clear solution was then kept under reflux and stirred for 30 minutes. The closed flask was then kept for 30 minutes in a bath of ice and water, then in a thermostatic water bath at 25° C. for 30 minutes. The resulting solid was filtered on quick filtering paper. 100 ml of the filtered liquid were poured into a pre-weighed aluminum container, which was heated on a heating plate under nitrogen flow, thereby removing the solvent by evaporation. The container was then kept in an oven at 80° C. under vacuum, until a constant weight was obtained. The weight percentage of polymer soluble in xylene at room temperature was then calculated.

The content of the xylene-soluble fraction is expressed as a percentage of the original 2.5 grams and then, by the difference (complementary to 100%), the xylene insoluble percentage (%).

### Melt Flow Rate (MFR)

Measured according to ISO 1133 at 230° C. with a load of 2.16 kg, unless otherwise specified.

### Intrinsic Viscosity (IV)

The sample was dissolved in tetrahydronaphthalene at 135° C. and then poured into a capillary viscometer. The viscometer tube (Ubbelohde type) was surrounded by a cylindrical glass jacket. This setup allowed for temperature control with a circulating thermostatic liquid. The downward passage of the meniscus was timed by a photoelectric device.

The passage of the meniscus in front of the upper lamp started the counter which had a quartz crystal oscillator. The counter stopped as the meniscus passed the lower lamp. The efflux time was registered and converted into a value of intrinsic viscosity through Huggins' equation (Huggins, M. L., J. Am. Chem. Soc., 1942, 64, 2716), using the flow time of the pure solvent at the same experimental conditions (same viscometer and same temperature). A single polymer solution was used to determine [η].

### Ethylene (C2) Content

### ¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules 1982, 15, 4, 1150-1152) using the following equations:

$$\begin{matrix}PPP = 100 {T}_{β β} / S & PPE = 100 {T}_{β δ} / S & EPE = 100 {T}_{δδ} / S \\ PEP = 100 {S}_{β β} / S & PEE = 100 {S}_{β δ} / S & EEE = 10 \; 0 ( 0.25 {S}_{γ δ} + {0.5}_{δδ} ) / S\end{matrix}$$

$$S = {T}_{β β} + {T}_{β δ} + {T}_{δ δ} + {S}_{β β} + {S}_{β δ} + 0.25 {S}_{γ δ} + 0.5 {S}_{6 δ}$$

The molar percentage of ethylene content was evaluated using the following equation:

$$E \% = 100 * [ PEP + PEE + EEE ]$$

The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

### Samples for the Mechanical Tests

Samples were obtained according to ISO 1873-2:2007.
Charpy impact test was determined according to ISO 179-1eA, and ISO 1873-2
Elongation at yield: measured according to ISO 527.
Elongation at break: measured according To ISO 527
Stress at break: measured according to ISO 527.
Tensile Modulus according to ISO 527-2,

Tear Resistance according to the method ASTM D 1004 on 1 mm-thick extruded sheets. Crosshead speed: 51 mm/min; V-shaped die cut specimen.

Shore D on injection molded, compression molded plaques and extruded sheets according to the method ISO 868 (15 sec)

### Melting Point and Crystallization Point

The melting point was measured by using a DSC instrument according to ISO 11357-3, at scanning rate of 20 C/min both in cooling and heating, on a sample of weight between 5 and 7 mg., under inert N₂ flow. Instrument was calibrated with Indium.

### Examples

### Preparation of Components (B)

### Catalyst System and Prepolymerization:

Before introducing the solid catalyst component into the polymerization reactors, the solid catalyst component (ZN107) was contacted at 30° C. for 9 minutes with aluminum triethyl (TEAL) and dicyclopentyldimethoxysilane (DCPMS) at a TEAL/DCPMS weight ratio of about 15 and in such a quantity that the TEAL/solid catalyst component weight ratio was about 4.

The catalyst system was then subjected to prepolymerization by suspending the catalyst system in liquid propylene at 50° C. for about 75 minutes before introducing the catalyst system into the first polymerization reactor.

### Polymerization

The polymerization was carried out in continuous mode in a series of three gas-phase reactors, equipped with devices to transfer the product from the first reactor to the second reactor. A propylene-based polymer (A) was produced in the first gas phase polymerization reactor by feeding the prepolymerized catalyst system, hydrogen (the molecular weight regulator) and propylene, with the components in a gas state, in a continuous and constant flow. The propylene-based polymer (A) coming from the first reactor was discharged in a continuous flow and, after having been purged of unreacted monomers, introduced, in a continuous flow, into the second gas phase reactor, together with quantitatively constant flows of hydrogen and ethylene, with the components in a gas state. In the second reactor, a copolymer of ethylene (B) was produced. The product coming from the second reactor was discharged in a continuous flow and, after having been purged of unreacted monomers, introduced, in a continuous flow, into the third gas phase reactor, together with quantitatively constant flows of hydrogen, ethylene and propylene, with the components in a gas state. In the third reactor, an ethylene-propylene polymer (C) was produced. Polymerization conditions, molar ratio of the reactants and compositions of the resulting copolymers are shown in Table 1. The polymer particles exiting the third reactor were subjected to a steam treatment, thereby removing the reactive monomers and volatile substances, and then dried. Thereafter, the polymer particles were mixed with a stabilizing additive composition in a twin screw extruder Berstorff ZE 25 (length/diameter ratio of screws: 34) and extruded under a nitrogen atmosphere in the following conditions:
Rotation speed: 250 rpm;
Extruder output: 15 kg/hour;
Melt temperature: 245° C.
   The stabilizing additive composition was made from or containing the following components:
0.1% by weight of Irganox® 1010;
0.1% by weight of Irgafos® 168; and
0.04% by weight of DHT-4A (hydrotalcite);
   where the percentage amounts refer to the total weight of the polymer and stabilizing additive composition.

Irganox® 1010 was 2,2-bis[3-[,5-bis(1,1-dimethylethyl)-4-hydroxyphenyl)-1-oxopropoxy]methyl]-1,3-propanediyl-3,5-bis(1,1-dimethylethyl)-4-hydroxybenzene-propanoate, and Irgafos® 168 was tris(2,4-di-tert.-butylphenyl)phosphite. The characteristics of the polymer composition, reported in Table 2, were obtained from measurements carried out on the extruded polymer, which constituted a stabilized ethylene polymer composition.

TABLE 1
Polymerization conditions

| Example | | 1 | 2 |
|---|---|---|---|
| 1^{st} Reactor - component (b1) | | | |
| Temperature | ° C. | 75 | 75 |
| Pressure | barg | 18 | 18 |
| H₂/C₃− | mol. | 0.036 | 0.034 |
| Split | wt % | 48 | 47 |
| MFR of (b1) | g/10 min | 32 | nd |
| 2^{nd} Reactor - component (b2) | | | |
| Temperature | ° C. | 65 | 65 |
| Pressure | barg | 15 | 15 |
| H₂/C₂− | mol. | 0.013 | 0.009 |
| C₂−/(C₂− + C₃−) | mol. | 0.207 | 0.204 |
| Split | wt % | 52 | 53 |
| C₂− content of B | wt % | 34 | 34 |
| Xylene soluble of (b1 + b2) | wt % | 48 | 49 |
| Xylene soluble IV | dl/g | 4.96 | 5.54 |
| MFR of (b1 + b2) | g/10 min. | 0.8 | 0.7 |

### Examples 1 and Comparative Examples 1-3

In this series of examples, a mixture of recycled PE (QCP5603) and recycled PP (QCP 300P) in various ratios, were introduced in an extruder (Berstorff extruder), wherein the mixture was admixed with 10% (based on the total amount of polyolefins) of a heterophasic composition used as compatibilizer and 1000 ppm of M.S. 168 as an additive. The polymer particles were extruded under nitrogen atmosphere in a twin screw extruder, at a rotation speed of 250 rpm and a melt temperature of 200-250° C. The characterization of the obtained composition is reported in Table 2.

Compatibilizers used are:
B1—Component B produced in run 1
B2 Component B produced in run 2
CC1—comparative compatibilizer produced according to Example 1 of Patent Cooperation Treaty Publication No. WO2020/182436
CC2 comparative compatibilizer produced according to Example 1 of Patent Cooperation Treaty Publication No. WO03/01 1962, after visbreaking at 15 g/10 min.

TABLE 2

| | | CE1 | CE2 | Example 1 | CE3 |
|---|---|---|---|---|---|
| | | Composition | | | |
| | | | 30% | 30% | 30% |
| | | 30% | QCP300P | QCP300P | QCP300P |
| | | QCP300P | 60% | 60% | 60% |
| | | 70% | QCP5603 | QCP5603 | QCP5603 |
| | Units | QCP5603 | 10% CC1 | 10% B1 | 10% CC2 |
| Melt Flow Rate | g/10 min | 1.85 | 2 | 2.07 | 3.33 |
| Elastic Modulus | N/mm² | 1030 | 880 | 910 | 850 |
| RES.CHARPY | KJ/m² | 29.5 | 71.3 | 82.4 | 60 |
| 23° C. | | | | | |
| RES.CHARPY | KJ/m² | 5.2 | 31.7 | 49.2 | 7.3 |
| 0° C. | | | | | |
| RES.CHARPY | KJ/m² | 3.7 | 4.8 | 5.4 | 3.9 |
| −20° C. | | | | | |
| Load at yield | N/mm² | 24.8 | 21.5 | 21.8 | 21 |
| Elongation at | % | 10.9 | 13 | 12.7 | 13.1 |
| yield | | | | | |
| Load at break | N/mm² | 16.2 | 17.2 | 16.6 | 15.8 |
| Elongation at | % | 150 | 590 | 430 | 500 |
| break | | | | | |

### Example 2 and Comparative Examples 4-5

In this series of examples, the same approach disclosed in example 1 and comparative examples 1-3 was followed with the difference that talc was added as a further component. The characterization of the resulting composition is reported in Table 3.

TABLE 3

| | | CE4 | Example 2 | CE5 |
|---|---|---|---|---|
| | | Composition | | |
| | | 30% | 30% | 30% |
| | | QCP300P | QCP300P | QCP300P |
| | | 56% | 56% | 56% |
| | | QCP5603 | QCP5603 | QCP5603 |
| | | 10% CC1 | 10% B1 | 10% CC2 |
| | Units | 4% talc | 4% talc | 4% talc |
| Melt Flow Rate | g/10 min | 2.33 | 2.05 | 3.42 |
| Elastic | N/mm² | 980 | 1050 | 980 |
| Modulus | | | | |
| RES.CHARPY | KJ/m² | 62.3 | 76.3 | 39.6 |
| 23° C. | | | | |
| RES.CHARPY | KJ/m² | 18.6 | 29.7 | 5.6 |
| 0° C. | | | | |
| RES.CHARPY | KJ/m² | 4.8 | 5.1 | 3.7 |
| −20° C. | | | | |
| Load at yield | N/mm² | 22 | 22.1 | 21.6 |
| Elongation at | % | 12.1 | 12.3 | 12.1 |
| yield | | | | |
| Load at break | N/mm² | 14.5 | 17.3 | 14.7 |
| Elongation at | % | 370 | 540 | 220 |
| break | | | | |

### Example 3 and Comparative Examples 6-8

In this series of examples, the same approach disclosed in example 1 and comparative examples 1-3 was followed with the difference that the relative amount of recycled PE (QCP5603) and recycled PP (QCP 300P) was varied. The characterization of the obtained composition is reported in Table 4.

TABLE 4

| | | CE6 | CE7 | Example 3 | CE8 |
|---|---|---|---|---|---|
| | | Composition | | | |
| | | | 60% | 60% | 60% |
| | | 70% | QCP300P | QCP300P | QCP300P |
| | | QCP300P | 30% | 30% | 30% |
| | | 30% | QCP5603 | QCP5603 | QCP5603 |
| | Units | QCP5603 | 10% CC1 | 10% B1 | 10% CC2 |
| Melt Flow Rate | g/10 min | 7.74 | 6.16 | 5.19 | 7.8 |
| Elastic Modulus | N/mm² | 1190 | 1010 | 1010 | 960 |
| RES.CHARPY | KJ/m² | 8 | 12.6 | 15.7 | 13.8 |
| 23° C. | | | | | |
| RES.CHARPY | KJ/m² | 4.1 | 7.1 | 7.7 | 6.8 |
| 0° C. | | | | | |
| RES.CHARPY | KJ/m² | 2.4 | 3.9 | 4.1 | 3.3 |
| −20° C. | | | | | |
| Load at yield | N/mm² | 25.8 | 22.9 | 23 | 22.1 |
| Elongation at | % | 10.5 | 11.9 | 11.7 | 12.6 |
| yield | | | | | |
| Load at break | N/mm² | 15.9 | 14.7 | 15.5 | 15.3 |
| Elongation at | % | 77.8 | 300 | 430 | 180 |
| break | | | | | |

### Example 4-5 and Comparative Examples 9-10

In this series of examples, the same approach disclosed in example 1 and comparative examples 1-3 was followed. With the difference that a blend (A) of 50 wt % of Hostalen GF 9055 F a virgin high density polyethylene, commercially available from LyondellBasell, and 50 wt % of Moplen HP561R a virgin polypropylene homopolymer, commercially available from LyondellBasell, was prepared. The characterization of the obtained composition is reported in Table 5.

Moreover, a cast film was obtained from the above composition was tested and characterized. The results are reported in Table 6.

The gels count test was carried out on a cast film Collin Extrusion line diameter with a 25 mm single screw with the following features:
Single screw L/D 25
Temperature profile
Cylinders 200 (close to the hopper)->230° C. (at the end of the extruder, before the inlet to the die)
Die 240° C.
Die width 150 mm
Chill roll 30° C.
Film speed 3.0 m/min
Film thickness 50 micron
Inspected area 1 m2
OCS FS gel count unit on a 4 cm wide strip.
   The elongation at break of cast films was measured, in machine direction (MD) and transversal direction (TD) according to ASTM D 882.

TABLE 5

| | | Example 4 | Example 5 | CE9 | CE10 |
|---|---|---|---|---|---|
| | | Composition | | | |
| | | 85% A | 95% A | 85% A | 95% A |
| | Units | 15% B2 | 5% B2 | 15% CC3 | 5% CC3 |
| Melt Flow Rate | g/10 min | 5.1 | 6.61 | 5.61 | 6.68 |
| RES.CHARPY | N/mm² | 59.5 | 7.6 | 11.6 | 6.4 |
| 23° C. | | | | | |
| RES.CHARPY | KJ/m² | 6.7 | 3.5 | 4.4 | 3.4 |
| 0° C. | | | | | |
| RES.CHARPY | KJ/m² | 3.9 | 2.3 | 3.5 | 2.5 |
| −20° C. | | | | | |
| Elastic Modulus | KJ/m² | 1000 | 1140 | 1120 | 1180 |
| Load at yield | N/mm² | 23.8 | 26.5 | 26.4 | 27.4 |
| Elongation at | % | 12.3 | 10.7 | 11 | 10.3 |
| yield | | | | | |
| Load at break | N/mm² | 17.1 | 16.4 | 17.9 | 2.5 |
| Elongation at | % | 620 | 520 | 600 | 350 |
| break | | | | | |

CC3 is a heterophasic TPO (thermoplastic polyolefin) polypropylene grade, having a total ethylene content of 11.0 wt % and a fraction soluble in xylene at 25° C. of 29 wt %. The intrinsic viscosity of the fraction soluble in xylene at 25° C. was 6.8 dl/g, and the MFR was 1.7 g/10 min. The polyolefin was obtained as described for examples 1-4 in Patent Cooperation Treaty Publication No. WO2004/08705.

TABLE 6

| | | Example 4 | Example 5 | CE9 | CE10 |
|---|---|---|---|---|---|
| Load at Yield | MPa | 21.6 | 23.8 | 22.6 | 23.7 |
| MD | | | | | |
| Elongation at | % | 13.1 | 11.4 | 11.4 | 11.4 |
| yield MD | | | | | |
| Load at break | MPa | 47.8 | 47.8 | 47 | 44.1 |
| MD | | | | | |
| Elongation at | % | 1106 | 1133 | 1071 | 1076 |
| Break MD | | | | | |
| Load at Yield | MPa | 19.2 | 23.6 | 19.1 | 22.5 |
| TD | | | | | |
| Elongation at | % | 7.8 | 6.4 | 6.3 | 6.3 |
| yield TD | | | | | |
| Load at break | MPa | 31.9 | 33.7 | 31.1 | 33.6 |
| TD | | | | | |
| Elongation at | % | 991 | 1010 | 1005 | 977 |
| Break TD | | | | | |
| Elmendorf MD | gf | 148 | 63 | 90 | 51 |
| Pendulum | | 400 g | 400 g | 200 g | 400 g |
| Weight | | | | | |
| Thickness | micron | 50 | 50 | 50 | 50 |
| Elmendorf TD | gf | 87 | 66 | 90 | 66 |
| Pendulum | | 400 g | 400 g | 200 g | 400 g |
| Weight | | | | | |
| Thickness | micron | 50 | 50 | 50 | 50 |
| Gels diam. | nr/m² | 0 | 0 | 0 | 2 |
| 0.50-.7 mm | | | | | |
| Gels diam. | nr/m² | 16 | 8 | 440 | 150 |
| >0.2 mm | | | | | |
| Gels diam. | nr/m² | 170 | 80 | 2690 | 950 |
| >0.1 mm | | | | | |

What is claimed is:

1. A polyolefin composition comprising:
(A) 60-95 wt % of a polyolefin component containing:
(a1) from 20 wt % to 80 wt % of a propylene based polymer, having a propylene content higher than 60 wt %; and
(a2) from 20 wt % to 80 wt % of an ethylene based polymer, having an ethylene content higher than 70 wt %; and
(B) 5-40 wt % of a polypropylene composition comprising:
(b1) from 35 to 65% by weight of a polymer fraction comprising a propylene homopolymer, or a copolymer of propylene with one or more comonomers selected from the group consisting of ethylene and CH₂═CHR alpha-olefins, where R is a C₂-C₈ alkyl radical, or mixtures thereof;
wherein the copolymers containing at least 85% by weight of units derived from propylene, and
(b2) from 35 to 65% by weight of a polymer fraction comprising a copolymer of ethylene with comonomers selected from the group consisting of propylene and CH₂═CHR alpha-olefins, where R is a C₂-C₈ alkyl radical,
wherein the copolymer containing units derived from ethylene in an amount ranging from 25 to 40% by weight
wherein the polypropylene composition (B) having
a Melt Flow Rate (ISO 1133 230° C./2.16 kg) ranging from 0.1 to 5 g/10 min;
an amount of fraction soluble in xylene at room temperature (25° C.) ranging from 35 to 60% by weight,
wherein the soluble fraction, having an intrinsic viscosity, measured in tetrahydronaphthalene at 135° C., ranging from 3.0 to 7.5 to dl/g; and
a total content of ethylene, determined by ¹³C-NMR, ranging from 10 to 25% by weight;
wherein the sum of a1) and a2), being referred to the total weight of (a1) and (a2), is 100, the sum of (b1) and (b2), being referred to the total weight of (b1) and (b2), is 100, and the sum of the amounts of (A) and (B), being referred to the total weight of (A) and (B), is 100.

2. The polyolefin composition according to claim 1, wherein:
component (A) is in an amount ranging from 65 to 95 wt %; and component (B) is in an amount ranging from 5 to 35 wt %.

3. The polyolefin composition according to claim 1, wherein the amount of component a1) ranges from 30 wt % to 70 wt %, based on the sum of a1)+a2).

4. The polyolefin composition according to claim 1, wherein component (a1) is a propylene based polymer, having a propylene content higher than 70 wt %.

5. The polyolefin composition according to claim 1, wherein the amount of component (a2) ranges from 30 wt % to 70 wt %, based on the sum of (a1)+(a2).

6. The polyolefin composition according to claim 1, wherein component (a2) is selected from ethylene based polymers, having an ethylene content higher than 70 wt %.

7. The polyolefin composition according to claim 1, wherein component (A) originates from a waste material containing not less than 80% by weight, with respect to the total weight of the component, of polyethylene, polypropylene, or mixtures thereof.

8. The polyolefin composition according to claim 1, wherein component (b1) is present in an amount from 40 to 60% by weight with respect to component (B) and is a propylene homopolymer.

9. The polyolefin composition according to claim 1, wherein the component (b2) is present in an amount from 40 to 60% by weight, with respect to component (B), and is a copolymer of ethylene with comonomers selected from the group consisting of propylene and CH₂═CHR alpha-olefins, where R is a C₂-C₈ alkyl radical, wherein the copolymer containing units derived from ethylene in an amount ranging from 28 to 35% by weight.

10. The polyolefin composition according to claim 1, wherein polypropylene composition (B) has a Melt Flow Rate (ISO 1133 230° C./2.16 kg) ranging from 0.2 to 2.5 g/10 min.

11. The polyolefin composition according to claim 1, wherein polypropylene composition (B) has an amount of fraction soluble in xylene at room temperature (25° C.) ranging from 40 to 55% by weight, wherein the soluble fraction, having an intrinsic viscosity, measured in tetrahydronaphthalene at 135° C., ranging from 4.0 to 6.5 dl/g.

12. The polyolefin composition according to claim 1, wherein polypropylene composition (B) has a total content of ethylene, determined by ¹³C-NMR, ranging from 13 to 23% by weight.

13. The polyolefin composition according to claim 1, wherein Melt Flow Rate (ISO 1133 230° C./2.16 kg) of the whole polyolefin composition ranges from 0.5 to 30 g/10 min.

14. An article of manufacture comprising the polyolefin composition according to claim 1.

15. The article of manufacture according to claim 14 being a cast, blown or bioriented films, mono or multilayer.
